(19) United States
(12) Patent Application Publication
(10) Pub. No.: US 2019/0026327 A1
(43) Pub. Date: Jan. 24, 2019

(54) METHOD AND APPARATUS FOR CONTROLLING MAP-SIDE AGGREGATION OF USER TASK IN A MAPREDUCE COMPUTING PLATFORM

(71) Applicant: ALIBABA GROUP HOLDING LIMITED, George Town (KY)

(72) Inventors: Yuanqiao JIA, Hangzhou (CN); Weiguang SUN, Hangzhou (CN)

(21) Appl. No.: 16/138,831

(22) Filed: Sep. 21, 2018

Related U.S. Application Data
(63) Continuation of application No. PCT/CN2017/075948, filed on Mar. 8, 2017.

(30) Foreign Application Priority Data
Mar. 21, 2016 (CN) 201610161897.5

(51) Int. Cl. G06F 17/30

(52) U.S. Cl. CPC G06F 17/30339; G06F 17/30489

(57) ABSTRACT

The present disclosure relates to a method and apparatus for controlling map-side aggregation of a user task in a MapReduce (MR) computing platform. The method for controlling map-side aggregation of a user task in an MR computing platform includes: receiving a submitted user task; detecting whether the received user task satisfies a preset map-side aggregation enabling condition; and controlling, according to a result of the detection, whether map-side aggregation of the user task is to be enabled.

### CROSS-REFERENCE TO RELATED APPLICATION

The present application is a continuation of International Application No. PCT/CN2017/075948, filed on Mar. 8, 2017, which is based upon and claims priority to Chinese Patent Application No. 201610161897.5, filed on Mar. 21, 2016, both of which are incorporated herein by reference in their entireties.

### TECHNICAL FIELD

The present disclosure relates to the field of communications, and in particular, to a method and an apparatus for controlling map-side aggregation of a user task in a MapReduce (MR) computing platform.

### BACKGROUND

An MR task runs on an MR computing platform of the distributed system. On the MR computing platform, an execution process of a user task involves several steps. First, a submitted user task is converted into multiple independent MR jobs, after which the MR jobs are executed in parallel to complete the user task. The execution process of the MR jobs involves a map-side aggregation.

The map-side aggregation is illustrated here by using an example involving finding the maximum in 1, 2, 3, 4, and 5. First, the data is divided into two groups based on a data volume, for example [1, 2, 3] and [4, 5]. Then, the maximums [3] and [5] of the two groups of data are found respectively, and [3] and [5] are further combined into [3, 5], after which the maximum of 5 is identified. When a map in the MR jobs is executed, the system can aggregate data on a map side if the processing function of map-side aggregation is in an enabled state. On the other hand, an exemplary solution without using the map-side aggregation would involve combining data into [1, 2, 3, 4, 5] based on a data volume, and then finding the maximum 5.

The processing of map-side aggregation by itself takes a certain amount of execution time. If the map-side aggregation achieves a desirable aggregation effect, the execution time of the MR jobs is reduced, thus improving the execution efficiency of the entire user task. If the map-side aggregation does not achieve an aggregation effect (which means that an input data volume of the map is equal to an output data volume), the execution time of the MR jobs may not be reduced. On the contrary, as the map-side aggregation also takes a certain amount of execution time, the execution time of the MR jobs will also be increased and the execution efficiency of the entire user task will be reduced compared to situations where the map-side aggregation is not performed. For large-scale MR computing platforms that perform big data processing, however, a significant number of user tasks are executed periodically, with the execution efficiency significantly improving the performance of the MR computing platform.

FIG. 1 is a schematic diagram of a conventional scenario of map-side aggregation. As shown in FIG. 1, in the process of finding the maximum of a group of data [1, 2, 3, 4, 5, . . . , 50], the data is divided into five groups, and the maximums of the five groups are determined by five threads respectively. Then, the maximum of the results obtained by the five threads is determined. Finally, the maximum of [1, 2, 3, 4, 5, . . , 50] is obtained. Such a processing manner may have good performance but may need to consume more computing resources. The maximum of the group of data [1, 2, 3, 4, 5, . . . , 50] can also be found in the following two cases, case 1 and case 2.

In case 1, the data [1, 2, 3, 4, 5, . . . , 50] is taken as one group, and one thread calculates the maximum of [1, 2, 3, 4, 5, . . . , 50].

In case 2, the data [1, 2, 3, 4, 5, . . . , 50] is divided into 50 groups. Fifty threads calculate the maximums of the 50 groups respectively, and then the maximum of the results obtained by the fifty threads is calculated.

In case 1, 50 numbers are processed in a group, and the performance is poor. In case 2, one number is processed in each of the groups, but a subsequently started thread needs to still process 50 numbers. The performance is likewise poor and more computing resources are consumed.

Neither case 1 nor case 2 achieves a desirable performance for aggregation. Therefore, the map-side aggregations in case 1 and case 2 are ineffective.

Currently, in the related art, a conventional processing system of the MR computing platform either enables or disables map-side aggregation for all user tasks. Such an inflexible manner can neither improve the execution efficiency of a user task by using the effective map-side aggregation nor prevent ineffective map-side aggregation from reducing the execution efficiency of the user task.

### SUMMARY

Embodiments of the present disclosure provide a method and apparatus for controlling map-side aggregation of a user task in an MR computing platform, so as to improve the execution efficiency of a user task and enhance the performance of the MR computing platform.

In accordance with some embodiments of the present disclosure, there is provided a method for controlling map-side aggregation of a user task in an MR computing platform. The method includes receiving a submitted user task. The method also includes detecting whether the received user task satisfies a preset map-side aggregation enabling condition. The method further includes controlling, according to a result of the detection, whether map-side aggregation of the user task is to be enabled.

In accordance with some embodiments of the present disclosure, there is provided an apparatus for controlling map-side aggregation of a user task in an MR computing platform. The apparatus includes a receiving module configured to receive a submitted user task. The apparatus also includes a detection module configured to detect whether the user task received by the receiving module satisfies a preset map-side aggregation enabling condition. The apparatus further includes a control module configured to control, according to a result of the detection by the detection module, whether map-side aggregation of the user task is to be enabled.

In accordance with some embodiments of the present disclosure, there is provided an apparatus for controlling map-side aggregation of a user task in an MR computing platform. The apparatus includes one or more memories configured to store executable program code and one or more processors configured to read the executable program code stored in the one or more memories to cause the apparatus to receive a submitted user task. The apparatus is also caused to detect whether the received user task satisfies a preset map-side aggregation enabling condition. The apparatus is further caused to control, according to a result of the detection, whether map-side aggregation of the user task is to be enabled.

In accordance with some embodiments of the present disclosure, there is provided a non-transitory computer-readable storage medium storing a set of instructions that is executable by one or more processors of an electronic device to cause the electronic device to perform a method for controlling map-side aggregation of a user task in a MapReduce computing platform. The method includes receiving a submitted user task. The method also includes detecting whether the received user task satisfies a preset map-side aggregation enabling condition. The method further includes controlling, according to a result of the detection, whether map-side aggregation of the user task is to be enabled.

### BRIEF DESCRIPTION OF THE DRAWINGS

FIG. 1 is a schematic diagram of a conventional scenario of map-side aggregation;

FIG. 2 is a flowchart of an exemplary method for controlling map-side aggregation of a user task in an MR computing platform according to some embodiments of the present disclosure;

FIG. 3 is a flowchart of an exemplary method for controlling map-side aggregation of a user task in an MR computing platform according to some embodiments of the present disclosure;

FIG. 4 is a flowchart of an exemplary method for controlling map-side aggregation of a user task in an MR computing platform according to some embodiments of the present disclosure;

FIG. 5 is a block diagram of an exemplary apparatus for controlling map-side aggregation of a user task in an MR computing platform according to some embodiments of the present disclosure;

FIG. 6 is a block diagram of an exemplary apparatus for controlling map-side aggregation of a user task in an MR computing platform according to some embodiments of the present disclosure; and

FIG. 7 is a block diagram of an exemplary apparatus for controlling map-side aggregation of a user task in an MR computing platform according to some embodiments of the present disclosure.

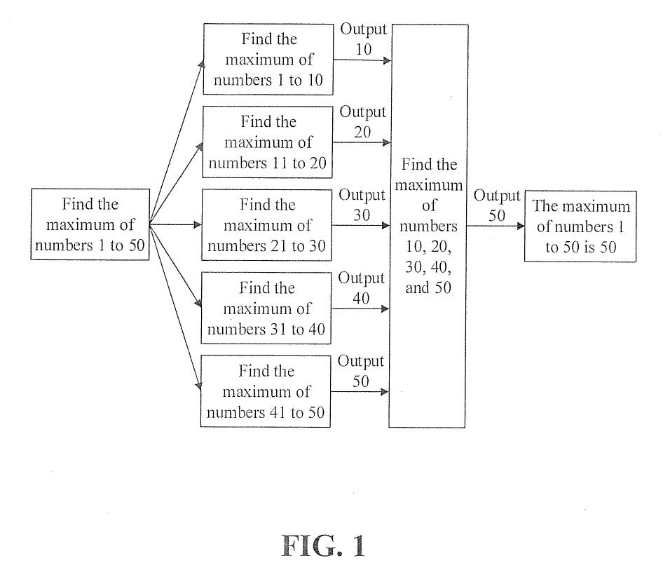

### DETAILED DESCRIPTION

The principle and features of the present disclosure are described in the following with reference to the accompanying drawings. Embodiments listed are merely used for illustrating the present disclosure and are not intended to limit the scope of the present disclosure. All embodiments obtained by those of ordinary skill in the art according to the spirit of the present disclosure without creative efforts belong to the protection scope of the present disclosure.

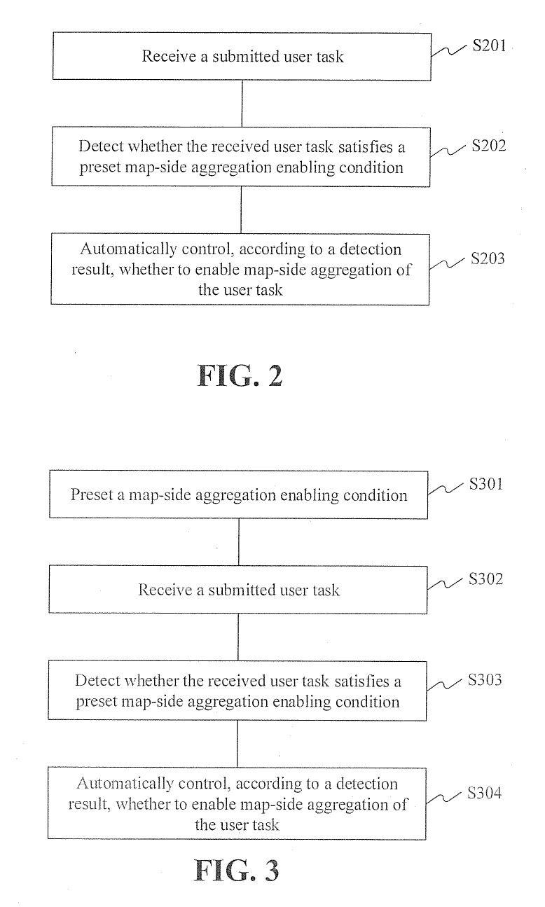

FIG. 2 is a flowchart of an exemplary method for controlling map-side aggregation of a user task in an MR computing platform according to some embodiments of the present disclosure. As shown in FIG. 2, in these embodiments, the method for controlling map-side aggregation of a user task in an MR computing platform can include steps S201-S203.

In step S201, a submitted user task is received.

In step S202, it is detected whether the received user task satisfies a preset map-side aggregation enabling condition. The map-side aggregation enabling condition refers to that effective map-side aggregation can be submitted for the user task. That the user task satisfies the map-side aggregation enabling condition usually means that map-side aggregation performed for the user task is determined to be effective and can improve the performance of the MR computing platform. That the user task does not satisfy the map-side aggregation enabling condition usually means that map-side aggregation performed for the user task is determined to be ineffective, which wastes a lot of computing resources while failing to improve the performance of the MR computing platform.

The map-side aggregation enabling condition can include: the user task being a non-CREATE TABLE statement, and an aggregation key being neither a primary key of a physical table of the user task nor a foreign key of the physical table of the user task.

A physical table can be a data storage structure in a database, and can be referred to as a table.

A primary key can refer to a field that can uniquely determine a record in a physical table. For example, a student table (student number, name, gender, class) includes four fields: student number, name, gender, and class, wherein the student number can uniquely determine a record in the student table. Here, the student number is a primary key of the student table. A primary key of a physical table can also be referred to as a primary keyword.

A foreign key can be a field that can determine records in another table and is used for keeping data consistency. A foreign key can be used for association with another table. For example, if a field in table A is a primary key of table B, the field can be a foreign key of table A. For example, in the foregoing student table (student number, name, gender, class), the student number is a primary key of the student table. A computer operating record table (card number, student number, name, serial number) includes the field “student number,” and “student number” is the primary key of the student table. Here, “student number” in the computer operating record table (card number, student number, name, serial number) is a foreign key of the computer operating record table. A foreign key of a physical table can also be referred to as a foreign keyword.

It can be seen that the foreign key represents an association between two physical tables. A table that uses a foreign key of the other physical table as a primary keyword is referred to as a master table, and the table having the foreign key is referred to as a slave table of the master table.

An aggregation key can be explained with reference to an example illustrated in Table 1 below. Gender is an aggregation key if the total number of students of each gender in Table 1 needs to be calculated. Class is an aggregation key if the total number of students in each class in Table 1 needs to be calculated. It can be seen that a field in the table on which aggregation is performed is an aggregation key.

TABLE 1

| Class | Gender | Number of students |
|---|---|---|
| Grade 1 | Male | 10 |
| Grade 1 | Female | 20 |
| Grade 2 | Male | 15 |
| Grade 2 | Female | 18 |

Referring back to step S202, to facilitate reference, this map-side aggregation enabling condition is referred to as map-side aggregation enabling condition 1 for short in the following. When the aggregation key is a primary key or foreign key of the physical table, a result of the map-side aggregation is that an output is equal to an input, and the map-side aggregation is ineffective. Therefore, the map-side aggregation may be effective only when the aggregation key is neither the primary key of the physical table of the user task nor the foreign key of the physical table of the user task. The map-side aggregation enabling condition 1 may eliminate types of user tasks for which map-side aggregation is ineffective, and ineffective map-side aggregation for these types of user task may be avoided. Thus, the execution efficiency of user tasks can be improved, and the performance of the MR computing platform can be enhanced.

The CREATE TABLE statement can be CREATE TABLE statement or other CREATE TABLE statements in a Data Definition Language (DDL).

The foregoing map-side aggregation enabling condition 1 can be used to determine, for both a first-time-executed user task and a non-first-time-executed user task, whether map-side aggregation is to be enabled.

The map-side aggregation enabling condition can also include: the user task being a non-CREATE TABLE statement, and a ratio of a total input data volume to a total output data volume of map-side aggregation in a historical map-side aggregation record of the user task being greater than or equal to a preset ratio threshold. The ratio threshold can be set according to an empirical value. This map-side aggregation enabling condition is referred to as map-side aggregation enabling condition 2 for short in the following.

When the ratio of the total input data volume to the total output data volume of map-side aggregation in the historical map-side aggregation record of the user task is greater than or equal to the preset ratio threshold, it can indicate that map-side aggregation of the user task is effective. Therefore, map-side aggregation of the user task can be enabled. The map-side aggregation enabling condition 1 can eliminate types of user tasks for which map-side aggregation is ineffective by using a method similar to “blacklist.” The map-side aggregation enabling condition 2 can include types of user tasks for which map-side aggregation is effective by using a method similar to “white list.”

In an application, map-side aggregation enabling condition 2 is suitable for determining, for a non-first-time-executed user task, whether map-side aggregation is to be enabled.

The map-side aggregation enabling condition can further include: the user task being a non-CREATE TABLE statement, and map-side aggregation being manually set for the user task. This map-side aggregation enabling condition is referred to as map-side aggregation enabling condition 3 for short in the following.

Map-side aggregation enabling condition 3 enables the present disclosure to determine whether map-side aggregation is to be enabled according to a specific requirement of a user for a specific user task, which helps satisfy a personal requirement of the user and improves user satisfaction.

In an application, multiple map-side aggregation enabling conditions can be preset at the same time, and map-side aggregation of a user task is enabled as long as the user task satisfies one of the map-side aggregation enabling conditions.

In step S203, it is automatically controlled, according to a result of the detection, whether map-side aggregation of the user task is to be enabled. That is, when the received user task satisfies the preset map-side aggregation enabling condition, map-side aggregation of the user task is enabled. When the received user task does not satisfy the preset map-side aggregation enabling condition, map-side aggregation of the user task is disabled. As such, enabling of map-side aggregation of the user task can be controlled reasonably, so that map-side aggregation is performed effectively, avoiding a waste of resources and a decrease in the performance of the MR computing platform caused by ineffective map-side aggregation.

The method for controlling map-side aggregation of a user task in an MR computing platform in these embodiments of the present disclosure can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced.

FIG. 3 is a flowchart of an exemplary method for controlling map-side aggregation of a user task in an MR computing platform according to some embodiments of the present disclosure. As shown in FIG. 2, the method for controlling map-side aggregation of a user task in an MR computing platform in these embodiments can include steps S301 -S304.

In step S301, a map-side aggregation enabling condition is preset. Through this step, a user can set or modify a map-side aggregation enabling condition according to features of a user task, so that the map-side aggregation enabling condition adapts to the features of the user task. Thus, the processing efficiency can be improved. For example, all user tasks to be processed have been executed before. In other words, all the user tasks to be processed are not executed for the first time. In this case, it is feasible to set only one map-side aggregation enabling condition, such as the foregoing map-side aggregation enabling condition 2. As such, it may be unnecessary to make determinations based on all map-side aggregation enabling conditions one by one. Thus, the execution efficiency of user tasks can be further improved, and the performance of the MR computing platform can be further enhanced.

In step S302, a submitted user task is received.

In step S303, it is detected whether the received user task satisfies the preset map-side aggregation enabling condition.

In step S304, it is automatically controlled, according to a result of the detection, whether map-side aggregation of the user task is to be enabled. The method for controlling map-side aggregation of a user task in an MR computing platform in these embodiments of the present disclosure can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced. Moreover, the method for controlling map-side aggregation of a user task in an MR computing platform in these embodiments of the present disclosure can further enable a user to set or modify a map-side aggregation enabling condition according to features of a user task, so that the map-side aggregation enabling condition adapts to the features of the user task. Thus, the execution efficiency of the user task can be further improved, and the performance of the MR computing platform can be further enhanced.

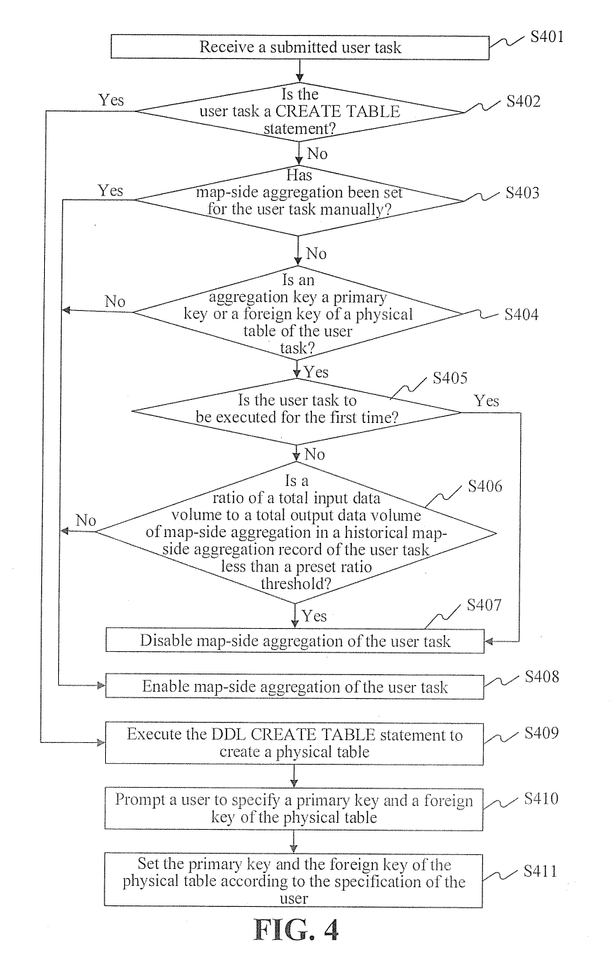

FIG. 4 is a flowchart of an exemplary method for controlling map-side aggregation of a user task in an MR computing platform according to some embodiments of the present disclosure. As shown in FIG. 4, the method for controlling map-side aggregation of a user task in an MR computing platform in these embodiments can include steps S401-S411.

In step S401, a submitted user task is received.

In step S402, it is detected whether the user task is a CREATE TABLE statement. If the user task is a CREATE TABLE statement, step S409 is performed. If the user task is a not a CREATE TABLE statement (or the user task is a non-CREATE TABLE statement), step S403 is performed.

In step S403, it is detected whether map-side aggregation has been set for the user task manually. If the map-side aggregation has been set for the user task manually, step S408 is performed. If the map-side aggregation has not been set for the user task manually, step S404 is performed.

In step S404, it is detected whether an aggregation key of a physical table of the user task is a primary key or a foreign key of the physical table of the user task. If the aggregation key is the primary key or the foreign key of the physical table of the user task, step S 405 is performed. If the aggregation key is neither the primary key nor the foreign key of the physical table of the user task, step S408 is performed.

In step S405, it is detected whether the user task is to be executed for the first time. If the user task is to be executed for the first time, step S407 is performed. If the user task is not to be executed for the first time, step S406 is performed.

In step S406, it is detected whether a ratio of a total input data volume to a total output data volume of map-side aggregation in a historical map-side aggregation record of the user task is less than a preset ratio threshold. If the ratio is less than the preset ratio threshold, step S407 is performed. If the ratio is not less than the preset ratio threshold, step S408 is performed.

In step S407, map-side aggregation of the user task is disabled, and the procedure ends.

In step S408, map-side aggregation of the user task is enabled, and the procedure ends.

In step S409, the CREATE TABLE statement is executed to create a physical table.

In step S410, the user is prompted to specify a primary key and a foreign key of the physical table created in step S409.

In step S411, the primary key and the foreign key of the created physical table are set according to the specification of the user, and the procedure ends.

If the user does not specify the primary key and the foreign key of the physical table, it can be assumed by default that the physical table has no primary key or foreign key.

After the primary key and the foreign key are set for the physical table, it can be convenient to subsequently determine, based on the foregoing map-side aggregation enabling condition 1, whether to perform map-side aggregation for a user task related to the physical table. This can help expand the range of user tasks for which determination can be made effectively.

The method for controlling map-side aggregation of a user task in an MR computing platform in these embodiments of the present disclosure can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced.

The present disclosure further proposes an apparatus for controlling map-side aggregation of a user task in an MR computing platform. The apparatus can be configured to implement the foregoing method for controlling map-side aggregation of a user task in an MR computing platform. The principle illustrated in the foregoing embodiments of the exemplary method for controlling map-side aggregation of a user task in an MR computing platform is also applicable to the following embodiments of the exemplary apparatus for controlling map-side aggregation of a user task in an MR computing platform.

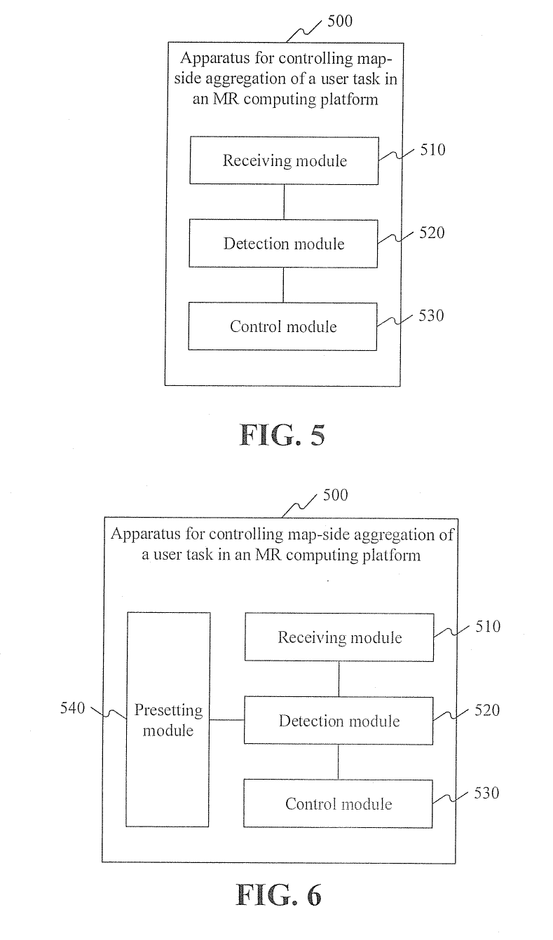

FIG. 5 is a block diagram of an exemplary apparatus for controlling map-side aggregation of a user task in an MR computing platform according to some embodiments of the present disclosure. As shown in FIG. 5, an apparatus 500 for controlling map-side aggregation of a user task in an MR computing platform in these embodiments can include a receiving module 510, a detection module 520 and a control module 530. Receiving module 510, detection module 520, and control module 530 can be connected in that order. Receiving module 510 can be configured to receive a submitted user task. Detection module 520 can be configured to detect whether the user task received by receiving module 510 satisfies a preset map-side aggregation enabling condition. Control module 530 can be configured to automatically control, according to a result of the detection by detection module 520, whether map-side aggregation of the user task is to be enabled.

The map-side aggregation enabling condition can include: the user task being a non-CREATE TABLE statement, and an aggregation key being neither a primary key of a physical table of the user task nor a foreign key of the physical table of the user task. A CREATE TABLE statement can be a DDL CREATE TABLE statement or other CREATE TABLE statements.

The map-side aggregation enabling condition can further include: the user task being a non-CREATE TABLE statement, and a ratio of a total input data volume to a total output data volume of map-side aggregation in a historical map-side aggregation record of the user task being greater than or equal to a preset ratio threshold. The ratio threshold can be set according to an empirical value.

The map-side aggregation enabling condition can further include: the user task being a non-CREATE TABLE statement, and map-side aggregation being manually set for the user task.

In an application, multiple map-side aggregation enabling conditions can be preset at the same time, and control module 530 can enable map-side aggregation of a user task as long as the user task satisfies one of the map-side aggregation enabling conditions.

The apparatus for controlling map-side aggregation of a user task in an MR computing platform in these embodiments of the present disclosure can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced.

FIG. 6 is a block diagram of an exemplary apparatus for controlling map-side aggregation of a user task in an MR computing platform according to some embodiments of the present disclosure.

As shown in FIG. 6, apparatus 500 for controlling map-side aggregation of a user task in an MR computing platform in these embodiments can include a receiving module 510, a detection module 520, a control module 530, and a presetting module 540. Receiving module 510, detection module 520, and control module 530 can be connected in that order. Presetting module 540 can be connected to detection module 520. Receiving module 510 can be configured to receive a submitted user task. Detection module 520 can be configured to detect whether the user task received by receiving module 510 satisfies a preset map-side aggregation enabling condition. Control module 530 can be configured to automatically control, according to a result of the detection by detection module 520, whether map-side aggregation of the user task is to be enabled. Presetting module 540 is configured to preset the map-side aggregation enabling condition.

Using presetting module 540, a user can set or modify a map-side aggregation enabling condition according to features of a user task, so that the map-side aggregation enabling condition adapts to the features of the user task. Thus, the processing efficiency can be improved.

The apparatus for controlling map-side aggregation of a user task in an MR computing platform in these embodiments of the present disclosure can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced. Moreover, the apparatus for controlling map-side aggregation of a user task in an MR computing platform in these embodiments of the present disclosure can further enable a user to set or modify a map-side aggregation enabling condition according to features of a user task, so that the map-side aggregation enabling condition adapts to the features of the user task. Thus, the execution efficiency of the user task can be further improved, and the performance of the MR computing platform can be further enhanced.

In some embodiments of the present disclosure, the apparatus for controlling map-side aggregation of a user task in an MR computing platform can further include a creation module, a prompt module, and a setting module. The prompt module and the setting module can be connected to the creation module, respectively. The creation module can be configured to: in the case where the user task is a CREATE TABLE statement, execute the CREATE TABLE statement to create a physical table. The prompt module can be configured to prompt a user to specify a primary key and a foreign key of the physical table created by the creation module. The setting module can be configured to set, according to the specification of the user, the primary key and the foreign key of the physical table created by the creation module.

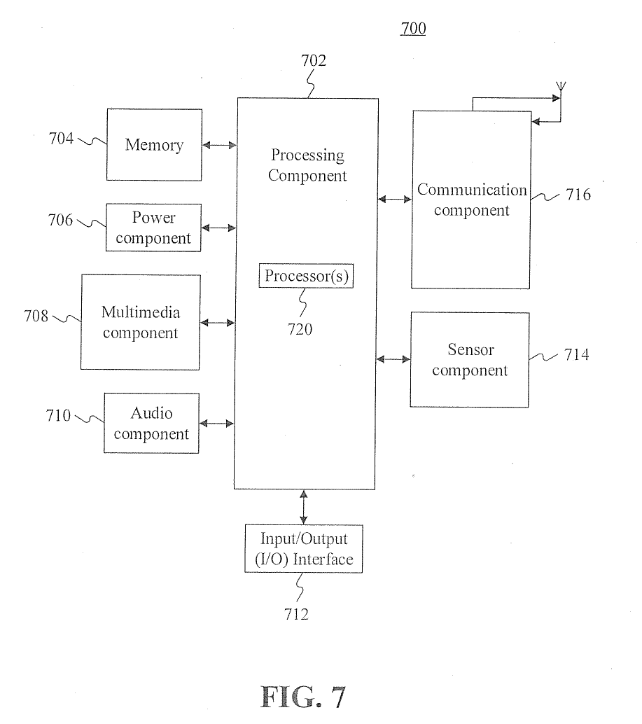

FIG. 7 is a block diagram of an exemplary apparatus for controlling map-side aggregation of a user task in an MR computing platform according to some embodiments of the present disclosure. As shown in FIG. 7, an apparatus 700 for controlling map-side aggregation of a user task in an MR computing platform can include one or more of the following components: a processing component 702, a memory 704, a power component 706, a multimedia component 708, an audio component 710, an input/output (I/O) interface 712, a sensor component 714, and a communication component 716.

Processing component 702 usually controls the overall operation of apparatus 700 for controlling map-side aggregation of a user task in an MR computing platform. For example, processing component 702 can control operations associated with displaying, a phone call, data communication, a camera operation, and a record operation. Processing component. 702 can include one or more processors 720 to execute instructions, so as to complete all or some of the steps of the foregoing method. The steps can include: receiving a submitted user task; detecting whether the received user task satisfies a preset map-side aggregation enabling condition; and automatically controlling, according to a result of the detection, whether map-side aggregation of the user task is to be enabled. In addition, processing component 702 can include one or more modules to facilitate interaction between processing component 702 and other components. For example, processing component 702 can include a multimedia module to facilitate interaction between multimedia component 708 and processing component 702.

Memory 704 is configured to store various types of data to support operations in apparatus 700 for controlling map-side aggregation of a user task in an MR computing platform. Examples of the data include an instruction of any application program or method, contact data, address book data, a message, a picture, a video, and the like used to be operated on apparatus 700 for controlling map-side aggregation of a user task in an MR computing platform. Memory 704 can be implemented by any type of volatile or non-volatile storage devices or their combination, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

Power component 706 supplies power for various components of apparatus 700 for controlling map-side aggregation of a user task in an MR computing platform. Power component 706 can include a power management system, one or more power sources, and other components associated with power generation, management, and distribution for apparatus 700 for controlling map-side aggregation of a user task in an MR computing platform.

Multimedia component 708 can include a screen that provides an output interface between apparatus 700 for controlling map-side aggregation of a user task in an MR computing platform and a user. In some embodiments, the screen can include a liquid crystal display (LCD) and a touch panel (TP). If the screen includes a TP, the screen can be implemented as a touch screen to receive an input signal from the user. The TP includes one or more touch sensors to sense a touch, a slide, and a gesture on the TP. The TP not only can sense the boundary of a touch or slide action but also can detect the duration and pressure related to the touch or slide operation. In some embodiments, multimedia component 808 can include a front camera and/or a rear camera. When apparatus 700 for controlling map-side aggregation of a user task in an MR computing platform is in an operating mode, such as a shooting mode or a video mode, the front camera and/or the rear camera can receive external multimedia data. Each front camera and rear camera can be a fixed optical lens system or have focusing and optic zoom capabilities.

Audio component 710 can be configured to output and/or input an audio signal. For example, audio component 710 includes a microphone (MIC). When apparatus 700 for controlling map-side aggregation of a user task in an MR computing platform is in an operating mode, such as a calling mode, a recording mode, or a speech recognition mode, the MIC is configured to receive an external audio signal. The received audio signal can be further stored in memory 704 or sent by using communication component 716. In some embodiments, audio component 710 further includes a loudspeaker configured to output an audio signal.

I/O interface 712 provides an interface between processing component 702 and a peripheral interface module. The peripheral interface module can be a keyboard, a click wheel, buttons, and the like. The buttons can include, but are not limited to, a home button, a volume button, a start button, and a lock button.

Sensor component 714 can include one or more sensors configured to provide state evaluation of various aspects for apparatus 700 for controlling map-side aggregation of a user task in an MR computing platform. For example, sensor component 714 can detect an on/off state of apparatus 700 for controlling map-side aggregation of a user task in an MR computing platform, and can detect relative positioning of components. For example, the components include a display and a small keyboard of apparatus 700 for controlling map-side aggregation of a user task in an MR computing platform. Sensor component 714 can detect a position change of apparatus 700 for controlling map-side aggregation of a user task in an MR computing platform or a position change of a component of apparatus 700 for controlling map-side aggregation of a user task in an MR computing platform. Sensor component 714 can detect whether or not a user is in contact with apparatus 700 for controlling map-side aggregation of a user task in an MR computing platform. Sensor component 714 can detect the orientation or acceleration/deceleration of apparatus 700 for controlling map-side aggregation of a user task in an MR computing platform. Sensor component 714 can detect a temperature change of apparatus 700 for controlling map-side aggregation of a user task in an MR computing platform. Sensor component 714 can include a proximity sensor configured to detect the presence of an object nearby without any physical contact. Sensor component 714 can further include an optical sensor, such as a CMOS or CCD image sensor configured to be used in an imaging application. In some embodiments, sensor component 714 can further include an acceleration sensor, a gyroscope sensor, a magnetic sensor, a pressure sensor, or a temperature sensor.

Communication component 716 can be configured to facilitate wired or wireless communication between apparatus 700 for controlling map-side aggregation of a user task in an MR computing platform and other devices. Apparatus 700 for controlling map-side aggregation of a user task in an MR computing platform can access a wireless network based on a communications standard, for example, WiFi, 2G, 3G, 4G or a combination thereof In some embodiments, communication component 716 receives a broadcast signal or broadcast-related information from an external broadcast management system via a broadcast channel. In some embodiments, communication component 716 further includes a near-field communication (NFC) module to facilitate near field communication. For example, the NFC module can be implemented based on a radio frequency identification (RFID) technology, an Infrared Data Association (IrDA) technology, an ultra-wideband (UWB) technology, a Bluetooth (BT) technology, and other technologies.

In some embodiments, apparatus 700 for controlling map-side aggregation of a user task in an MR computing platform can be implemented by one or more application-specific integrated circuits (ASICs), a digital signal processor (DSP), a digital signal processing device (DSPD), a programmable logic device (PLD), a field programmable gate array (FPGA), a controller, a microcontroller, a microprocessor or other electronic elements, and is configured to execute the foregoing method.

In some embodiments, a non-transitory computer readable storage medium including instructions is further provided. For example, a memory 704 including instructions can be provided. The instructions can be executed by processing component 702, which may include one or more processors 720, of apparatus 700 for controlling map-side aggregation of a user task in an MR computing platform to complete the foregoing method. For example, the non-transitory computer readable storage medium can be a ROM, a random access memory (RAM), a CD-ROM, a magnetic tape, a floppy disk, an optical data storage device, and so on.

Some embodiments of the present disclosure provides a non-transitory computer readable storage medium. When instructions in the storage medium are executed by a processor of a mobile terminal, the mobile terminal can execute a method for controlling map-side aggregation of a user task in an MR computing platform The method can include: receiving a submitted user task; detecting whether the received user task satisfies a preset map-side aggregation enabling condition; and automatically controlling, according to a result of the detection, whether map-side aggregation of the user task is to be enabled.

The apparatus for controlling map-side aggregation of a user task in an MR computing platform in the foregoing embodiments can autonomously control whether to execute map-side aggregation for a user task according to a specific situation. Accordingly, effective map-side aggregation can be performed for the user task, and ineffective map-side aggregation can be avoided. Thus, the execution efficiency of the user task can be improved, and the performance of the MR computing platform can be enhanced.

Described above are merely some embodiments of the present disclosure, which are not intended to limit the present disclosure. Any modification, equivalent replacement, improvement and the like made within the spirit and principle of the present disclosure should be included in the protection scope of the present disclosure.

1. A method for controlling map-side aggregation of a user task in a MapReduce (MR) computing platform, comprising:
receiving a submitted user task;
detecting whether the received user task satisfies a preset map-side aggregation enabling condition; and
controlling, according to a result of the detection, whether map-side aggregation of the user task is to be enabled.

2. The method according to claim 1, wherein the preset map-side aggregation enabling condition comprises:
the user task being a non-CREATE TABLE statement, and an aggregation key being neither a primary key of a physical table of the user task nor a foreign key of the physical table of the user task.

3. The method according to claim 1, wherein the preset map-side aggregation enabling condition comprises:
the user task being a non-CREATE TABLE statement, and a ratio of a total input data volume to a total output data volume of map-side aggregation in a historical map-side aggregation record of the user task being greater than or equal to a preset ratio threshold.

4. The method according to claim 1, wherein the preset map-side aggregation enabling condition comprises:
the user task being a non-CREATE TABLE statement, and map-side aggregation being manually set for the user task.

5. The method according to claim 1, before receiving the submitted user task, further comprising:
presetting the map-side aggregation enabling condition.

6. The method according to claim 1, further comprising:
in response to the user task being a CREATE TABLE statement, executing the CREATE TABLE statement to create a physical table;
prompting a user to specify a primary key and a foreign key of the physical table; and
setting the primary key and the foreign key of the physical table according to the specification of the user.

7. An apparatus for controlling map-side aggregation of a user task in a MapReduce (MR) computing platform, comprising:
a receiving module configured to receive a submitted user task;
a detection module configured to detect whether the user task received by the receiving module satisfies a preset map-side aggregation enabling condition; and
a control module configured to automatically control, according to a result of the detection by the detection module, whether map-side aggregation of the user task is to be enabled.

8. The apparatus according to claim 7, wherein the preset map-side aggregation enabling condition comprises:
the user task being a non-CREATE TABLE statement, and an aggregation key being neither a primary key of a physical table of the user task nor a foreign key of the physical table of the user task.

9. The apparatus according to claim 7, wherein the preset map-side aggregation enabling condition comprises:
the user task being a non-CREATE TABLE statement, and a ratio of a total input data volume to a total output data volume of map-side aggregation in a historicalmap-side aggregation record of the user task being greater than or equal to a preset ratio threshold.

10. The apparatus according to claim 7, wherein the preset map-side aggregation enabling condition comprises:
the user task being a non-CREATE TABLE statement, and map-side aggregation being manually set for the user task.

11. The apparatus according to claim 7, further comprising:
a presetting module connected to the detection module and configured to preset the map-side aggregation enabling condition.

12. The apparatus according to claim 7, further comprising:
a creation module configured to, in response to the user task being a CREATE TABLE statement, execute the CREATE TABLE statement to create a physical table;
a prompt module configured to prompt a user to specify a primary key and a foreign key of the physical table; and
a setting module configured to set, according to the specification of the user, the primary key and the foreign key of the physical table.

13. An apparatus for controlling map-side aggregation of a user task in an MR computing platform, comprising:
one or more memories configured to store executable program code; and
one or more processors configured to read the executable program code stored in the one or more memories to cause the apparatus to perform:
receiving a submitted user task;
detecting whether the received user task satisfies a preset map-side aggregation enabling condition; and
controlling, according to a result of the detection, whether map-side aggregation of the user task is to be enabled.

14. The apparatus according to claim 13, wherein the preset map-side aggregation enabling condition comprises:
the user task being a non-CREATE TABLE statement, and an aggregation key being neither a primary key of a physical table of the user task nor a foreign key of the physical table of the user task.

15. The apparatus according to claim 13, wherein the preset map-side aggregation enabling condition comprises:
the user task being a non-CREATE TABLE statement, and a ratio of a total input data volume to a total output data volume of map-side aggregation in a historical map-side aggregation record of the user task being greater than or equal to a preset ratio threshold.

16. The apparatus according to claim 13, wherein the preset map-side aggregation enabling condition comprises:
the user task being a non-CREATE TABLE statement, and map-side aggregation being manually set for the user task.

17.-18. (canceled)

19. A non-transitory computer-readable storage medium storing a set of instructions that is executable by one or more processors of an electronic device to cause the electronic device to perform a method for controlling map-side aggregation of a user task in a MapReduce computing platform, the method comprising:
receiving a submitted user task;
detecting whether the received user task satisfies a preset map-side aggregation enabling condition; and
controlling, according to a result of the detection, whether map-side aggregation of the user task is to be enabled.

20. The non-transitory computer-readable storage medium of claim 19, wherein preset map-side aggregation enabling condition comprises:
the user task being a non-CREATE TABLE statement, and an aggregation key being neither a primary key of a physical table of the user task nor a foreign key of the physical table of the user task.

21. The non-transitory computer-readable storage medium of claim 19, wherein preset map-side aggregation enabling condition comprises:
the user task being a non-CREATE TABLE statement, and a ratio of a total input data volume to a total output data volume of map-side aggregation in a historical map-side aggregation record of the user task being greater than or equal to a preset ratio threshold.

22. The non-transitory computer-readable storage medium of claim 19, wherein preset map-side aggregation enabling condition comprises:
the user task being a non-CREATE TABLE statement, and map-side aggregation being manually set for the user task.

23.-24. (canceled)
